(19) United States
(12) Patent Application Publication
(10) Pub. No.: US 2017/0075879 A1
(43) Pub. Date: Mar. 16, 2017

(54) DETECTION APPARATUS AND METHOD

(71) Applicant: Kabushiki Kaisha Toshiba, Tokyo (JP)

(72) Inventors: Akiko SAKAMOTO, Kawasaki Kanagawa (JP); Kazuo SUMITA, Yokohama Kanagawa (JP)

(21) Appl. No.: 15/260,731

(22) Filed: Sep. 9, 2016

(30) Foreign Application Priority Data
Sep. 15, 2015 (JP) 2015-181403

(51) Int. Cl. G06F 17/27; G10L 15/26

(52) U.S. Cl. CPC G06F 17/2755; G10L 15/26; G06F 17/2735

(57) ABSTRACT

According to one embodiment, a detection apparatus includes a morpheme analyzer, a dependent structure analyzer and an extractor. the morpheme analyzer performs a morpheme analysis on a character string indicating an utterance content of a user to generate a morpheme analysis result including a plurality of morphemes. The dependent structure analyzer analyzes a dependency relation among the plurality of morphemes in the morpheme analysis result. The extractor extracts a unit of morphemes having a completely-linked dependent structure from the morpheme analysis result based on the dependency relation.

### CROSS-REFERENCE TO RELATED APPLICATIONS

This application is based upon and claims the benefit of priority from Japanese Patent Application No. 2015-181403, filed Sep. 15, 2015, the entire contents of which are incorporated herein by reference.

### FIELD

Embodiments described herein relate generally to a detection apparatus and method.

### BACKGROUND

In a speech translation technology, a user-uttered spoken language is input instead of inputting a written text polished in advance as in the conventional machine translation. Therefore, there are included words having no direct relation to the utterance content such as filler, hesitation, and restatement. Deleting such an unnecessary component is important because it affects on accuracy in translation processing at the post-processing. On the other hand, there is a manual work (“proofreading”) before publishing a document in a publishing field. As a natural language processing technology for automating the proofreading, there is a technology in which a prepared text is received, a proofreading target portion in the text is corrected to convert that portion into a correct word.

In addition, as another natural language processing technology, there is a technology in which a colloquial expression is converted into a written expression using a conversion pattern with respect to the morpheme string.

However, in the technologies for automating the above proofreading, it is assumed that the text is prepared in advance and the text is read on a character basis when analyzing the text. Therefore, in a case where the text is progressively (sequentially) input in a situation of a simultaneous interpretation of the spoken language, the text is not read on a character basis, and the analysis of the text is not possible. In addition, in a case where the colloquial expression is converted into the written expression only by a conversion pattern of the morpheme string, it is difficult to convert the text in consideration of a dependency relation among the morphemes included in the colloquial expression. Therefore, when a new sentence is uttered in the middle of uttering, or another sentence is inserted in the middle of speaking a certain sentence, the entire structure of the sentences is not converted.

### BRIEF DESCRIPTION OF THE DRAWINGS

FIG. 1 is a block diagram illustrating a detection apparatus according to a first embodiment;

FIG. 2 is a diagram illustrating an example of a conversion pattern which is stored in a conversion dictionary storage;

FIGS. 3A and 3B are diagrams illustrating an example of a conversion process of a morpheme pattern converter;

FIG. 4 is a diagram illustrating an example of an end expression dictionary which is stored in an end expression dictionary storage;

FIG. 5 is a flowchart illustrating an operation of the detection apparatus according to the first embodiment;

FIG. 6 is a flowchart illustrating a dependent structure analysis process according to the first embodiment in detail;

FIGS. 7A to 7E are diagrams illustrating an example of a scan morpheme string which is stored in a scan morpheme string buffer;

FIGS. 8A to 8G are diagrams illustrating an example of a table which is stored in a dependency source morpheme buffer;

FIG. 9 is a block diagram illustrating a detection apparatus according to a second embodiment;

FIG. 10 is a flowchart illustrating details of a dependent structure analysis process according to the second embodiment;

FIG. 11 is a diagram illustrating an example of a table of a morpheme analysis result including an inversion, which is stored in a dependency source morpheme buffer; and

FIG. 12 is a diagram illustrating an example of a correction result of an inversion corrector.

### DETAILED DESCRIPTION

A detailed description will now be given of an embodiment with reference to the accompanying drawings. In the descriptions set forth below, like reference numerals denote like elements or operations, and a redundant explanation will be omitted.

This embodiment is made to solve the above problems, and an object thereof is to provide a detection apparatus and method which can detect an appropriate processing unit.

In general, according to one embodiment, a detection apparatus includes a morpheme analyzer, a dependent structure analyzer and an extractor. the morpheme analyzer performs a morpheme analysis on a character string indicating an utterance content of a user to generate a morpheme analysis result including a plurality of morphemes. The dependent structure analyzer analyzes a dependency relation among the plurality of morphemes in the morpheme analysis result. The extractor extracts a unit of morphemes having a completely-linked dependent structure from the morpheme analysis result based on the dependency relation.

A detection apparatus according to this embodiment will be described on an assumption that a processing unit used in a natural language process or a translation process is detected and extracted.

### First Embodiment

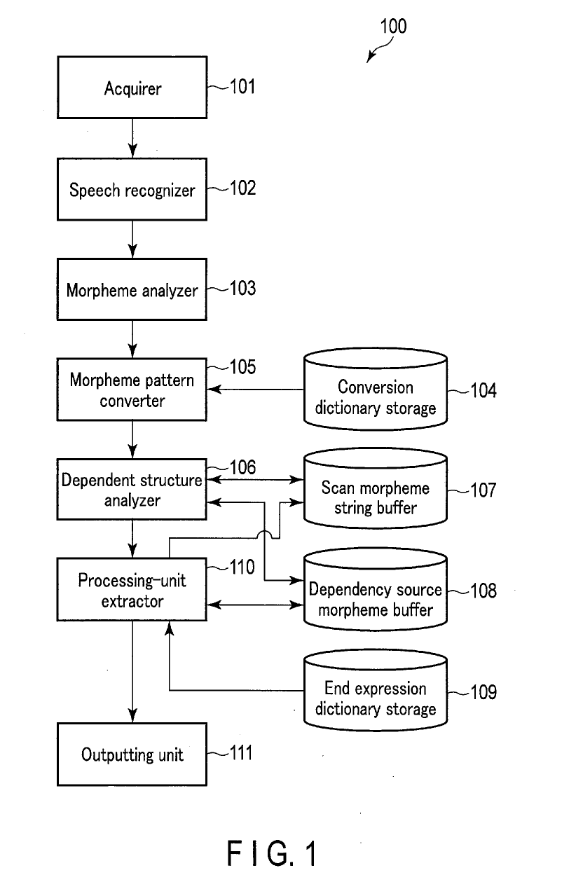

A detection apparatus according to a first embodiment will be described with reference to a block diagram of FIG. 1. A detection apparatus 100 according to the first embodiment includes an acquirer 101, a speech recognizer 102, a morpheme analyzer 103, a conversion dictionary storage 104, a morpheme pattern converter 105, a dependent structure analyzer 106, a scan morpheme string buffer 107, a dependency source morpheme buffer 108, an end expression dictionary storage 109, a processing-unit extractor 110, and an outputting unit 111.

The acquirer 101 acquires a speech based on a user's utterance through a microphone. It is assumed that the speech is a spoken language (colloquial expression), and the acquirer 101 gradually (sequentially) acquires the speech. Further, the acquirer 101 may sequentially acquire a character string indicating an utterance content of the user in place of the speech. For example, the acquirer 101 may acquire the utterance content of the user as a character string by an input method through a keyboard from the user or by a general input method such as a handwriting recognition.

The speech recognizer 102 receives the speech based on the user's utterance, and performs a speech recognition on the speech to generate a speech recognition result. Specifically, the speech recognition result is obtained by converting the speech into a character string (text), a word sequence, or a word lattice. In other words, the speech recognition result is a character string indicating the utterance content of the user. A speech recognition process may use a hidden Markov model (HMM) or a deep neural network (DNN) for example, or may use a widely-used scheme in the related art. Further, when receiving the character string indicating the utterance content of the user from the acquirer 101, the speech recognizer 102 only transfers the character string to the post-processing without any change.

The morpheme analyzer 103 receives the speech recognition result from the speech recognizer 102, and performs the morpheme analysis on the speech recognition result, and thus generates a morpheme analysis result including a plurality of morphemes. Further, even when receiving the character string indicating the utterance content of the user from the speech recognizer 102, the morpheme analyzer 103 similarly may perform the morpheme analysis on the sequentially-obtained character string to generate the morpheme analysis result.

The conversion dictionary storage 104 stores a conversion rule of a morpheme string. The conversion rule includes a morpheme serving as a conversion condition and a morpheme after conversion. Herein, a conversion pattern of a colloquial expression and a written expression is stored as the conversion rule.

The morpheme pattern converter 105 receives the morpheme analysis result from the morpheme analyzer 103, and converts the colloquial expression of the morpheme result into the written expression with reference to the conversion pattern which is stored in the conversion dictionary storage 104. Further, the morpheme pattern converter 105 may transfer the morpheme analysis result to the next stage without any change in a case where the morpheme analysis result is already converted into the written expression.

The dependent structure analyzer 106 receives the morpheme analysis result of the written expression from the morpheme pattern converter 105, analyzes the dependency relation among a plurality of morphemes in the morpheme analysis result, and obtains a dependent structure indicating a dependency relation. In an analysis process of the dependency relation, the dependent structure analyzer 106 has a dependency relation dictionary (not illustrated), and may analyze and determine a relation between a certain morpheme and another morpheme using a widely-used scheme in the related art such as a chart parsing algorithm for example.

The scan morpheme string buffer 107 receives the morpheme analysis result from the dependent structure analyzer 106, and stores the morpheme analysis result as a scan morpheme string which indicates the morpheme string of a processing target (for scanning). Furthermore, the scan morpheme string buffer 107 stores a pointer indicating an order of the morpheme to be processed among the stored morphemes.

The dependency source morpheme buffer 108 receives the morpheme analysis result and the dependent structure obtained by the analysis from the dependent structure analyzer 106, and stores the morpheme analysis result and the dependent structure. Furthermore, the dependency source morpheme buffer 108 stores a pointer indicating an order of the morpheme to be processed among the stored morphemes.

The end expression dictionary storage 109 stores an end expression as an end expression dictionary. Herein, the end expression is the morpheme string of an expression used at a phase end or a sentence end.

The processing-unit extractor 110 receives the morpheme analysis result from the dependent structure analyzer. The processing-unit extractor 110 extracts a unit (an appropriate processing unit) of morphemes having a completely-linked dependent structure from the morpheme analysis result with reference to the scan morpheme string buffer 107, the dependency source morpheme buffer 108, and the end expression dictionary storage 109.

The outputting unit 111 receives the unit (processing unit) of extracted morphemes from the processing-unit extractor 110, and outputs the processing unit to the outside.

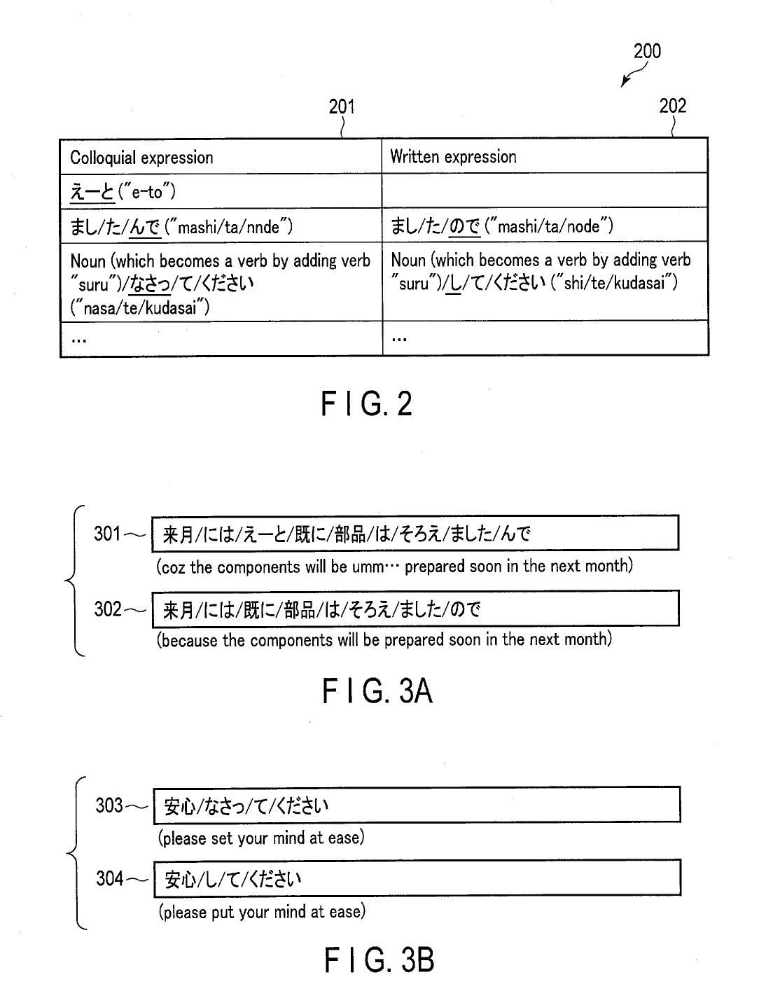

Next, an example of the conversion pattern stored in the conversion dictionary storage 104 will be described with reference to FIG. 2. A table 200 shown in FIG. 2 stores a colloquial expression 201 and a written expression 202 in association with each other. The colloquial expression 201 is a morpheme string of the spoken language including even a filler. The written expression 202 is a morpheme string a written language.

Specifically, the colloquial expression 201 “ [symbol] / [symbol] / [symbol] [symbol] ” (“mashi/ta/nnde” in pronunciation) is associated with the written expression 202 “ [symbol] / [symbol] / [symbol] ” (“mashi/ta/node” in pronunciation). Herein, “/” indicates a separation between the morphemes. Further, since there is no written expression 202 corresponding to the colloquial expression 201 “ [symbol] ” (“e-to” in pronunciation) in the table 200, the colloquial expression 201 “ [symbol] ” is deleted from the written expression 202.

Next, an example of a conversion process of the morpheme pattern converter 105 will be described with reference to FIGS. 3A and 3B. The morpheme pattern converter 105 converts the colloquial expression into the written expression with reference to the conversion pattern illustrated in FIG. 2. For example, as illustrated in FIG. 3A, a colloquial expression 301 “ [symbol] / [symbol] / [symbol] / [symbol] / [symbol] [symbol] / [symbol] / [symbol] / [symbol] / [symbol] ” (raigetsu/niha/e-to/sudeni/buhinn/ha/soroe/mashita/nnde) (“coz the components will be umm . . . prepared soon in the next month” in English) is converted into a written expression 302 “ [symbol] / [symbol] [symbol] / [symbol] / [symbol] / [symbol] / [symbol] / [symbol] / [symbol] ” (raigetsu/niha/sudeni/buhinn/ha/soroe/mashita/node) (“because the components will be prepared soon in the next month”). Similarly, as illustrated in FIG. 3B, a colloquial expression 303 “ [symbol] / [symbol] / [symbol] / [symbol] ” “(annshinn/nasa/tte/kudasai) (“please set your mind at ease”) is converted into a written expression 304 “ [symbol] / [symbol] / [symbol] / [symbol] ” (annshinn/shi/te/kudasai) (“please put your mind at ease”).

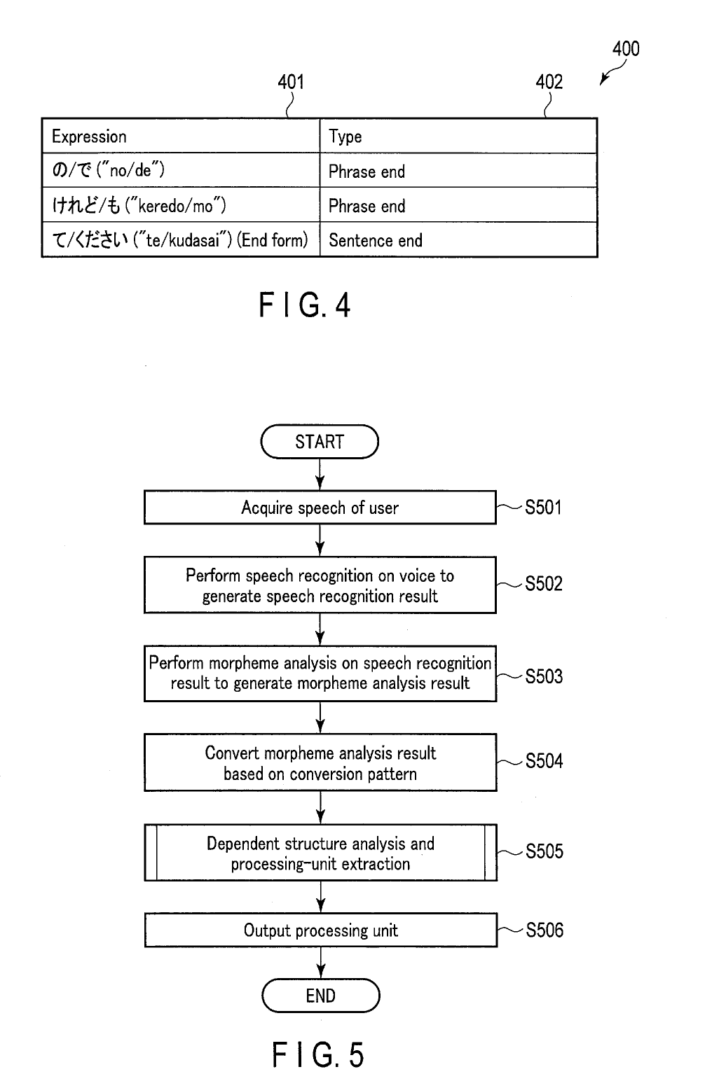

Next, an example of the end expression dictionary stored in the end expression dictionary storage 109 will be described with reference to FIG. 4. A table 400 stored in the end expression dictionary storage 109 includes an expression 401 and a type 402 in association with each other.

The expression 401 indicates the morpheme string which is used at the sentence end or at the phrase end. The type 402 indicates whether the morpheme string of the expression 401 is the phrase end or the sentence end. As a specific example, the expression 401 “ [symbol] / [symbol] ” (“no/de” in pronunciation) and the type 402 “phrase end” are associated.

Next, an operation of the detection apparatus 100 according to the first embodiment will be described with reference to a flowchart of FIG. 5. Further, the detection apparatus 100 performs the operation shown in FIG. 5 in sequence whenever a speech is input from the user or a speech indicating the utterance content of the user is input. In Step S501, the acquirer 101 acquires a user's speech. In Step S502, the speech recognizer 102 performs the speech recognition on the user's speech to generate the speech recognition result. In Step S503, the morpheme analyzer 103 performs the morpheme analysis on the speech recognition result to generate the morpheme analysis result.

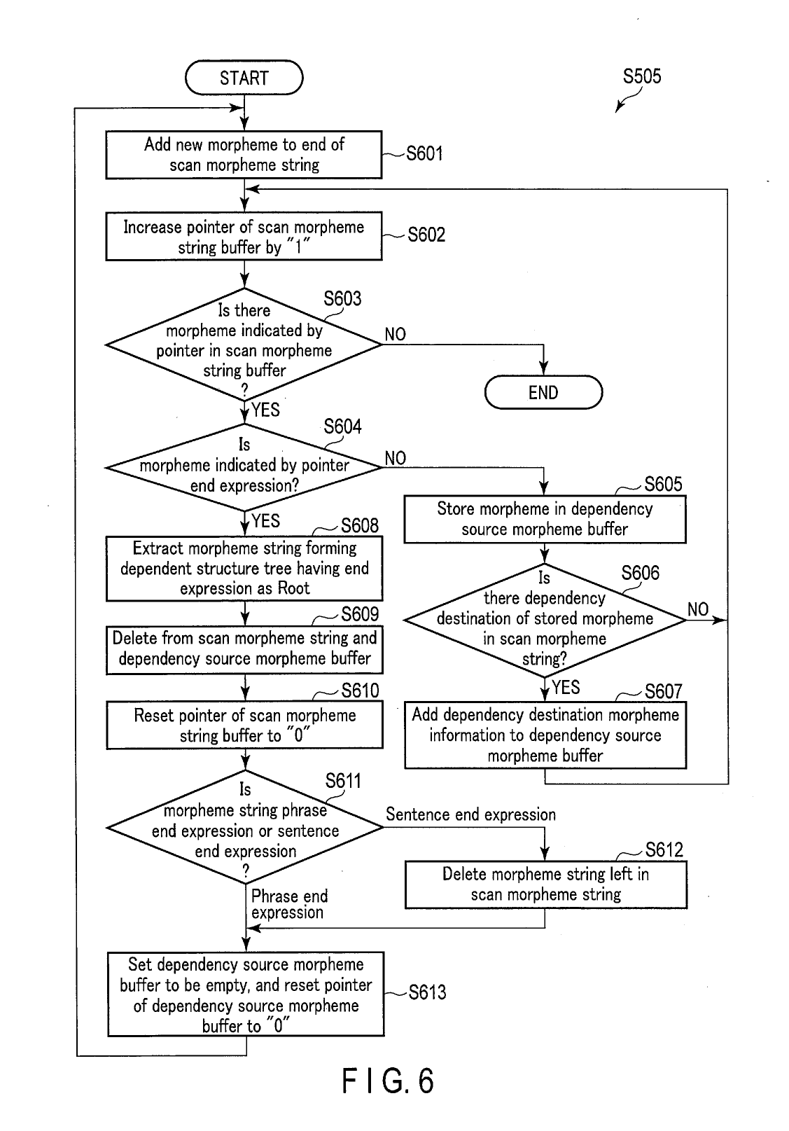

In Step S504, the morpheme pattern converter 105 converts the colloquial expression of the morpheme analysis result into the written expression based on the conversion pattern. In Step S505, the dependent structure analyzer 106 performs a dependent structure analysis and a processing-unit extraction process with respect to the morpheme analysis result of the written expression. A specific process will be described below with reference to FIG. 6. In Step S506, the outputting unit 111 outputs a processing unit obtained in Step S505. Then, the operation of the detection apparatus 100 according to the first embodiment is ended.

Next, the details of the dependent structure analysis and the processing-unit extraction process in Step S505 will be described with reference to a flowchart of FIG. 6. Further, an initial value of the pointer of the scan morpheme string buffer 107 is assumed as zero. In Step S601, the dependent structure analyzer 106 adds a new morpheme to the end of the scan morpheme string, and stores the string in the scan morpheme string buffer 107. Further, in a case where a morpheme is left in the scan morpheme string buffer 107 after returning from the process in Step S613, the new morpheme is added to the end of the left morphemes.

In Step S602, the processing-unit extractor 110 increases the pointer of the scan morpheme string buffer 107 by “1”.

In Step S603, the processing-unit extractor 110 determines whether there is a morpheme which is indicated by the pointer in the scan morpheme string buffer 107. In a case where there is the morpheme, the procedure proceeds to Step S604, and if not, the process is ended.

In Step S604, the processing-unit extractor 110 determines whether the morpheme indicated by the pointer of the scan morpheme string buffer 107 is the end expression (that is, a sentence end expression or a phrase end expression). In a case where the morpheme is the end expression, the procedure proceeds to Step S608. In a case where the morpheme is not the end expression, the procedure proceeds to Step S605.

In Step S605, the dependency source morpheme buffer 108 stores the morpheme which is indicated by the pointer of the scan morpheme string buffer 107.

In Step S606, the dependent structure analyzer 106 determines whether there is a dependency destination of the morpheme stored in Step S605 in the scan morpheme string. In a case where there is the dependency destination in the scan morpheme string, the procedure proceeds to Step S607. In a case where there is no dependency destination, the procedure returns to Step S602, and repeatedly performs Step S602 and the subsequent steps.

In Step S607, since a dependency destination morpheme serving as a dependency destination of the morpheme stored in Step S605 is found out, the dependency source morpheme buffer 108 additionally stores dependency destination morpheme information (information on the morpheme at the dependency destination) in association with the stored morpheme.

In Step S608, the processing-unit extractor 110 extracts the unit of morphemes having a completely-linked dependent structure (herein, as an example, the morpheme string (a first morpheme string) forming a dependent structure tree having the end expression (the sentence end expression or the phrase end expression) as a root).

In Step S609, the processing-unit extractor 110 deletes the morpheme string forming the dependent structure tree from the scan morpheme string buffer 107 and from the dependency source morpheme buffer 108. At this time, the morpheme string (a second morpheme string) is a difference between the scan morpheme string and the morpheme string (the first morpheme string) forming the dependent structure tree, and is stored in the scan morpheme string buffer 107 without any change.

In Step S610, the processing-unit extractor 110 resets the pointer of the scan morpheme string buffer 107 to zero.

In Step S611, the processing-unit extractor 110 determines whether the morpheme string is the sentence end expression or the phrase end expression. In a case where the morpheme string is the sentence end expression, the procedure proceeds to Step S612. In a case where the morpheme string is the phrase end expression, the procedure proceeds to Step S613.

In Step S612, the processing-unit extractor 110 deletes the morpheme string left in the scan morpheme string buffer 107.

In Step S613, the processing-unit extractor 110 deletes the data stored in the dependency source morpheme buffer 108 (the dependency source morpheme buffer 108 becomes empty), and the pointer of the dependency source morpheme buffer 108 is reset to zero. Thereafter, the process returns to Step S601, and the same processes are repeatedly performed. Then, the processes are ended.

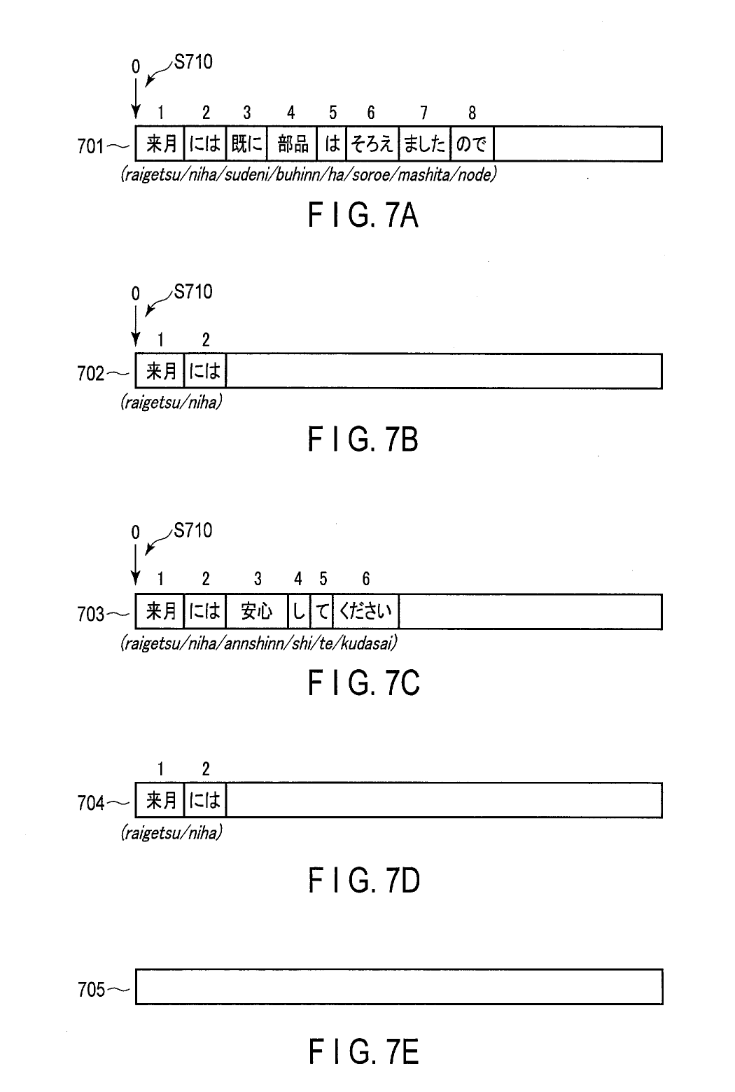

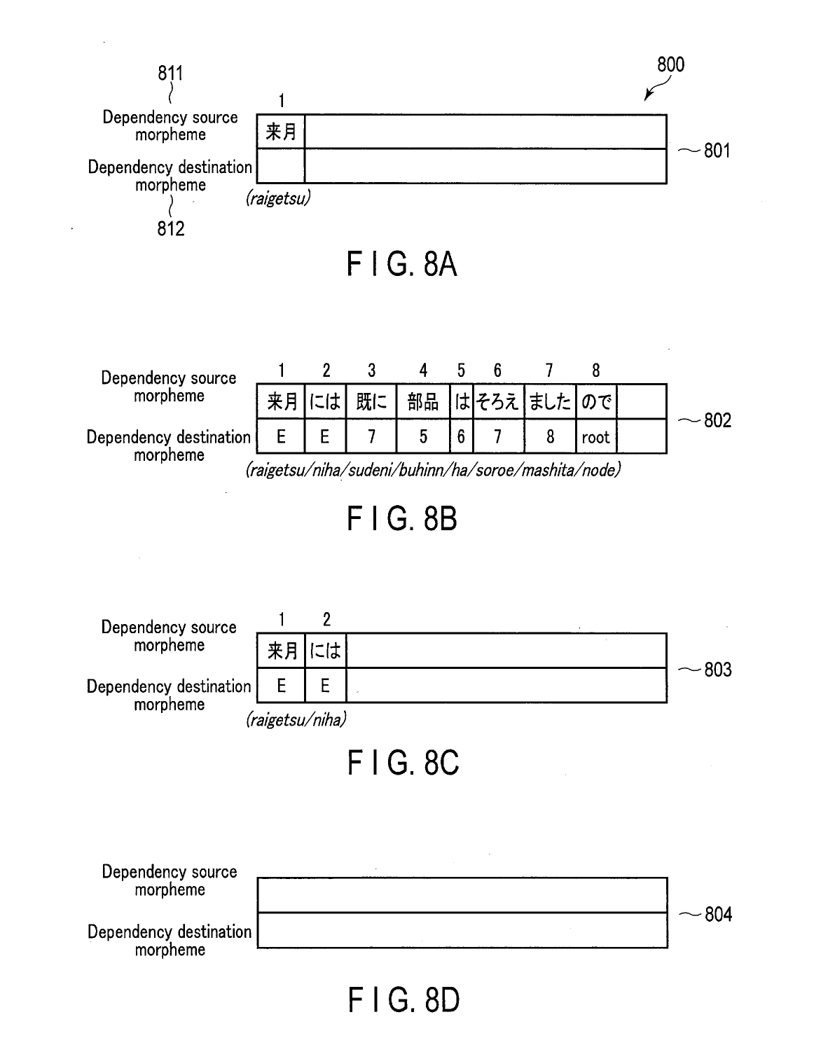

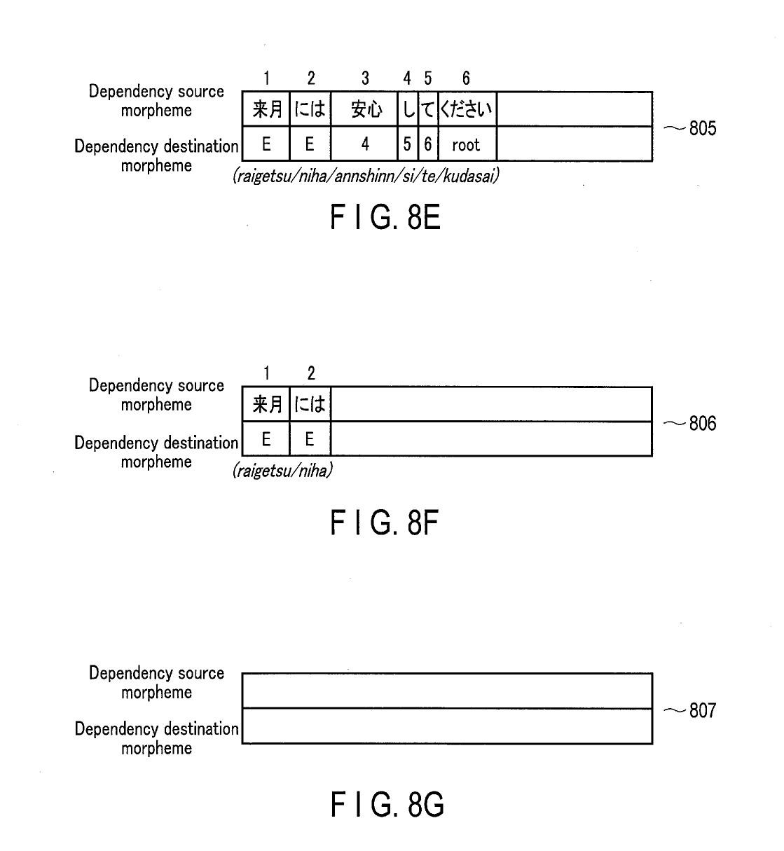

Next, a specific example of the dependent structure analysis and the processing-unit extraction process shown in FIG. 6 will be described with reference to FIGS. 7A to 8G. FIGS. 7A to 7E illustrate an example of the scan morpheme string which is stored in the scan morpheme string buffer 107. FIGS. 8A to 8G illustrate an example of a table showing a correspondence relation between the morpheme and the dependency source morpheme stored in the dependency source morpheme buffer 108.

Further, herein, the following processes are performed by the acquirer 101, the speech recognizer 102, the morpheme analyzer 103, and the morpheme pattern converter 105.

The acquirer 101 acquires an utterance “ [symbol] [symbol] [symbol] ” (raigetsu niha e-to sudeni buhinn ha soroemashitannde) (“coz the components will be umm . . . prepared soon in the next month” in English) from the user. Subsequently, the speech recognizer 102 recognizes the user's utterance “ [symbol] [symbol] [symbol] ”, and generates the character string “ [symbol] [symbol] [symbol] [symbol] ” as the speech recognition result.

Subsequently, the morpheme analyzer 103 performs the morpheme analysis on the speech recognition result to generate the morpheme analysis result of the colloquial expression “ [symbol] / [symbol] / [symbol] / [symbol] / [symbol] / [symbol] / [symbol] / [symbol] / [symbol] ” (raigetsu/niha/e-to/sudeni/buhinn/ha/soroe/mashita/nnde).

Subsequently, the morpheme pattern converter 105 converts the morpheme analysis result of the colloquial expression into the morpheme analysis of the written expression “ [symbol] / [symbol] / [symbol] / [symbol] / [symbol] / [symbol] / [symbol] / [symbol] ” (raigetsu/niha/sudeni/buhinn/ha/soroe/mashita/node) (“because the components will be prepared soon in the next month” in English).

In the above-described processes, the scan morpheme string buffer 107 receives the morpheme analysis result of the written expression from the dependent structure analyzer 106. The scan morpheme string buffer 107 stores a scan morpheme string 701 “ [symbol] / [symbol] / [symbol] / [symbol] / [symbol] / [symbol] / [symbol] / [symbol] ”, and assigns an identifier to each of the morphemes. Herein, identification numbers are assigned to the morphemes such that the morpheme “ [symbol] ” (raigetsu) is assigned with “1”, and the morpheme “ [symbol] ” (niha) is assigned with “2”.

In addition, the scan morpheme string buffer 107 stores a pointer 710, and sets an initial value to be positioned at zero of the identifier.

In the first process, the morpheme is not stored in the scan morpheme string buffer 107. Therefore, the morpheme string “ [symbol] / [symbol] / [symbol] / [symbol] / [symbol] / [symbol] / [symbol] ” is added as a new scan morpheme string (Step S601).

The pointer is increased by “1”, and indicates the morpheme “ [symbol] ” of the identifier “1” (Step S602 and Step S603).

Referring to the end expression dictionary storage 109, the morpheme “ [symbol] ” is not the end expression. Therefore, the morpheme “ [symbol] ” is stored in the dependency source morpheme buffer 108 (Step S604 and Step S605).

In a table 801 stored in the dependency source morpheme buffer 108 illustrated in FIG. 8A, a dependency source morpheme 811 and a dependency destination morpheme 812 are stored in association with each other. The dependency source morpheme 811 is a morpheme obtained from the scan morpheme string. The dependency destination morpheme 812 is a morpheme serving as a dependency source of the dependency source morpheme 811. The determination on the dependency source is made based on the analysis process of the dependency relation which is performed by the dependent structure analyzer 106.

In the table 801, the morpheme “ [symbol] ” is stored at the head. Since there is no morpheme serving as a counterpart related to the morpheme “ [symbol] ” in the scan morpheme string, the dependency destination morpheme 812 is set to be empty with respect to the dependency source morpheme 811 “ [symbol] ”, or “E” is stored (Step S606 and Step S607). “E” is an initial letter of “Empty”.

Subsequently, the scan morpheme string buffer 107 increases the pointer by “1”. Since the next morpheme is entered in the scan morpheme string, the next morpheme “ [symbol] [symbol] ” is processed (Step S602 and Step S603).

Referring to the end expression dictionary storage 109, the morpheme “ [symbol] ” is also the end expression, and thus the morpheme “ [symbol] ” is stored in the dependency source morpheme buffer 108 (Step S604 and Step S605).

The morpheme “ [symbol] ” is stored at the second position in the dependency source morpheme buffer 108. Since there is no morpheme serving as a dependency destination related to the morpheme “ [symbol] ” in the scan morpheme string, “Empty” is stored as the dependency destination morpheme 812 with respect to the dependency source morpheme (Step S606).

It is assumed that the above-described processes are repeatedly performed, the pointer progresses up to the eighth position, and the morpheme “ [symbol] ” (node) of the scan morpheme string is processed.

Referring to the end expression dictionary storage 109, it is determined that the morpheme “ [symbol] ” is the end expression (the phrase end expression) (Step S604). In this case, the table stored in the dependency source morpheme buffer 108 becomes a table 802 illustrated in FIG. 8B.

The processing-unit extractor 110 extracts the morpheme string forming the dependent structure tree using the morpheme “ [symbol] ” as a root. “ [symbol] / [symbol] / [symbol] / [symbol] / [symbol] / [symbol] ” (sudeni/buhinn/ha/soroe/mashita/node) can be obtained as a morpheme string which forms the dependent structure tree by performing the dependent structure analysis (Step S608).

Furthermore, the processing-unit extractor 110 deletes the morpheme string (the first morpheme string) “ [symbol] / [symbol] / [symbol] / [symbol] / [symbol] / [symbol] ” forming the dependent structure tree from the scan morpheme string buffer 107 and the dependency source morpheme buffer 108 (Step S609). The scan morpheme string stored in the scan morpheme string buffer 107 after the deletion is the second morpheme string that is a difference between the scan morpheme string and the first morpheme string, and a scan morpheme string 702 “ [symbol] ” (raigetsu niha) is left. In addition, the table stored in the dependency source morpheme buffer 108 becomes a table 803 illustrated in FIG. 8C.

Thereafter, the pointer in the scan morpheme string buffer 107 is reset to zero (Step S610). Furthermore, since the morpheme “ [symbol] ” is the phrase end expression, the processing-unit extractor 110 makes the dependency source morpheme buffer 108 empty, and resets the pointer (not illustrated) of the dependency source morpheme buffer to zero like a table 804 shown in FIG. 8D (Step S611 and Step S613). Next, it is assumed that the acquirer 101 acquires a new utterance “ [symbol] [symbol] ” (annshinn nasatte kudasai) (“please set your mind at ease” in English) from the user.

A dependent structure analysis process is performed on the morpheme analysis result “ [symbol] / [symbol] / [symbol] / [symbol] ” (annshinn/shi/te/kudasai) (“please put your mind at ease” in English) of the written expression by the speech recognizer 102, the morpheme analyzer 103, and the morpheme pattern converter 105.

Since the second morpheme string “ [symbol] ” is already stored, the scan morpheme string buffer 107 adds and stores the new morpheme “ [symbol] / [symbol] / [symbol] / [symbol] ” to the end of the morpheme “ [symbol] ” (Step S601 and Step S602). Therefore, the scan morpheme string buffer becomes a state of a scan morpheme string 703 illustrated in FIG. 7C.

Since the pointer is reset to zero by the process of Step S610, the processes from Step S603 to Step S608 are repeatedly performed from the morpheme “ [symbol] ” similarly. Herein, it is assumed that the processes up to the fifth morpheme “ [symbol] ” (te) are ended, the pointer is increased by “1”, and the process is performed on the sixth morpheme “ [symbol] [symbol] ” (kudasai).

Referring to the end expression dictionary storage 109, the sixth morpheme “ [symbol] ” is determined as the end expression (the sentence end expression) (Step S604). In this case, the table stored in the dependency source morpheme buffer 108 becomes a state of a table 805 illustrated in FIG. 8E.

The morpheme string forming the dependent structure tree is extracted using the morpheme “ [symbol] ” as a root. It is possible to obtain the morpheme string “ [symbol] / [symbol] / [symbol] / [symbol] [symbol] ” forming the dependent structure tree by performing the dependent structure analysis (Step S608).

The processing-unit extractor 110 deletes “ [symbol] / [symbol] / [symbol] / [symbol] ” from the scan morpheme string buffer 107 and the dependency source morpheme buffer 108 (Step S609). The scan morpheme string stored in the scan morpheme string buffer 107 in a case where the deletion is performed becomes a scan morpheme string 704 “ [symbol] ”. The table stored in the dependency source morpheme buffer 108 becomes a table 806 illustrated in FIG. 8F.

Thereafter, the processing-unit extractor 110 resets the pointer in the scan morpheme string buffer 107 to zero (Step S610). Furthermore, since the morpheme “ [symbol] ” is the sentence end expression (Step S611), the processing-unit extractor 110 deletes the morpheme string “ [symbol] ” Can left in the scan morpheme string like a scan morpheme string 705 illustrated in FIG. 7E (Step S612). Thereafter, the processing-unit extractor 110 sets the dependency source morpheme buffer 108 to be empty like a table 807 illustrated in FIG. 8G (Step S613).

According to the first embodiment described above, it is determined whether the morpheme is the end expression, and the morpheme string is output based on the dependency relation stored in the buffer, so that the completely-linked phrase is output as a processing unit while correcting the insertion often seen in the spoken language. Therefore, it is possible to detect an appropriate processing unit. For example, in a case where a processing system at the rear stage of the detection apparatus according to the first embodiment is a simultaneous interpretation system which uses the processing unit generated according to the first embodiment, the processing unit becomes an appropriate translation unit. Therefore, it is possible to obtain an effect of increasing simultaneity and accuracy in translation.

### Second Embodiment

A second embodiment is different from this embodiment in that an appropriate translation unit can be extracted from a sentence including an inversion in addition to a case where a character is inserted in the sentence.

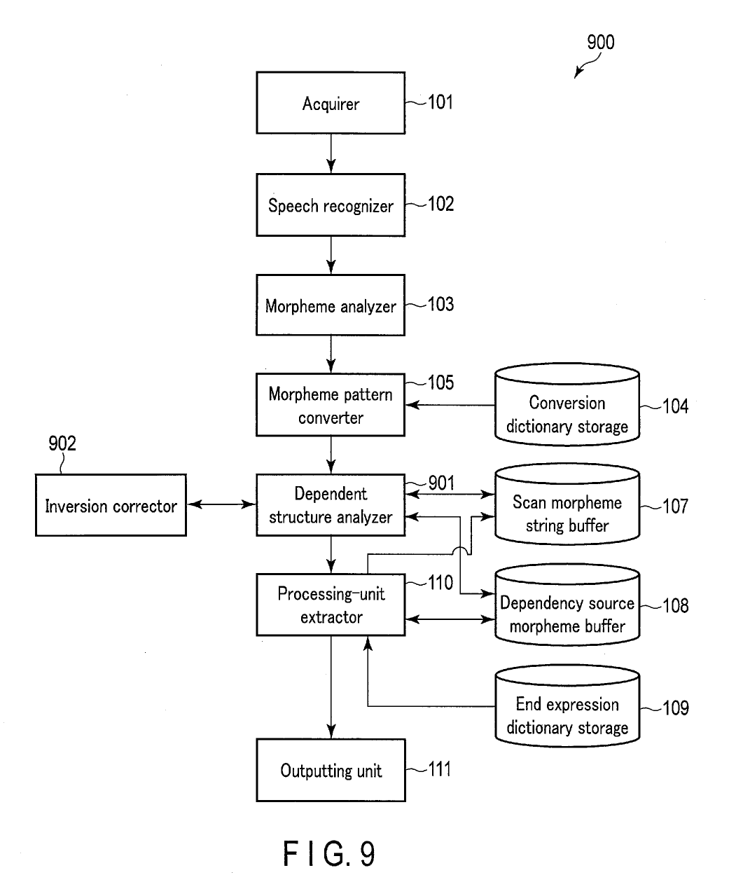

A detection apparatus according to the second embodiment will be described with reference to a block diagram of FIG. 9. A detection apparatus 900 according to the second embodiment includes an acquirer 101, a speech recognizer 102, a morpheme analyzer 103, a conversion dictionary storage 104, a morpheme pattern converter 105, a scan morpheme string buffer 107, a dependency source morpheme buffer 108, an end expression dictionary storage 109, a processing-unit extractor 110, an outputting unit 111, a dependent structure analyzer 901, and an inversion corrector 902.

The components other than the dependent structure analyzer 901 and the inversion corrector 902 perform the same processes, and the descriptions thereof will be omitted herein.

The dependent structure analyzer 901 determines whether a morpheme analysis result includes an inversion in addition to the process described in the first embodiment. In a case where the morpheme analysis result includes an inversion, the morpheme analysis result is transferred to the inversion corrector 902.

The inversion corrector 902 receives the morpheme analysis result including an inversion from the dependent structure analyzer 901, and corrects the inversion portion according to a correction rule. After correcting the inversion, the inversion corrector 902 sends the corrected morpheme analysis result to the dependent structure analyzer 901.

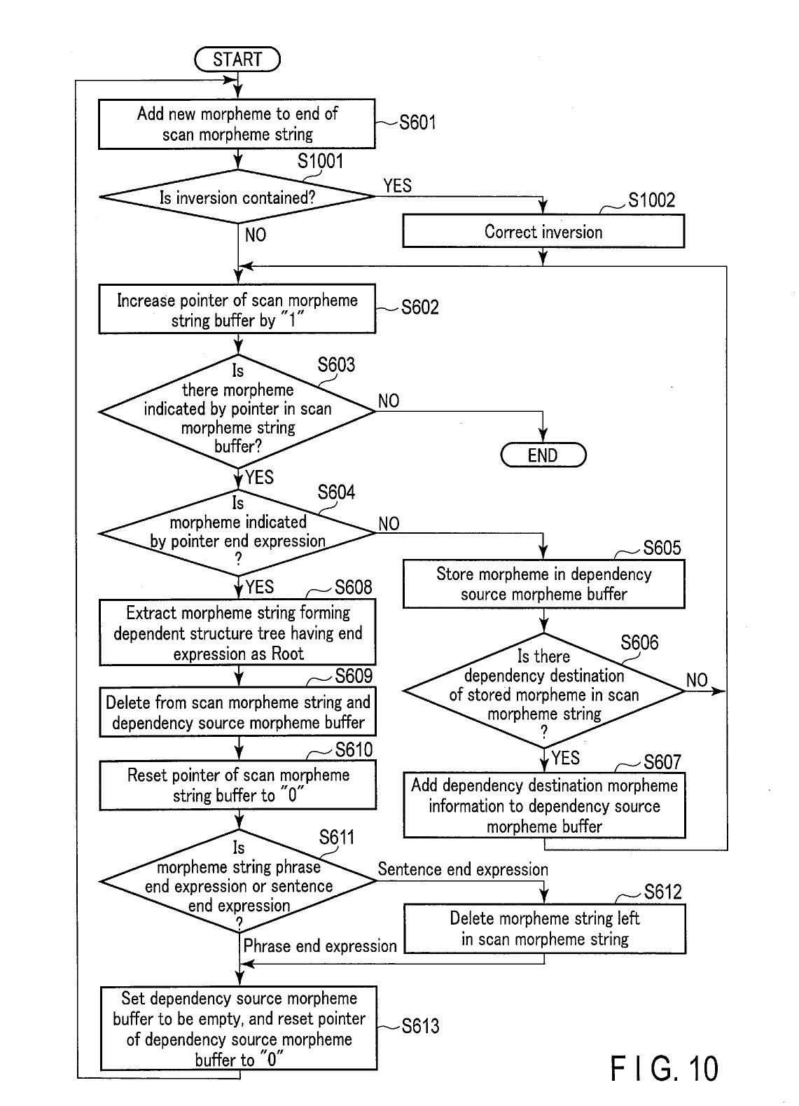

Next, the details of a dependent structure analysis process according to the second embodiment will be described with reference to a flowchart of FIG. 10.

Further, the steps other than Steps S1001 and S1002 are the same processes, and the descriptions thereof will be omitted herein.

In Step S1001, the dependent structure analyzer 901 determines whether the morpheme analysis result includes an inversion. In a case where an inversion is included in the morpheme analysis result, the procedure proceeds to Step S1002. In a case where an inversion is not included in the morpheme analysis result, the procedure proceeds to Step S601.

In Step S1002, the inversion corrector 902 corrects the inversion.

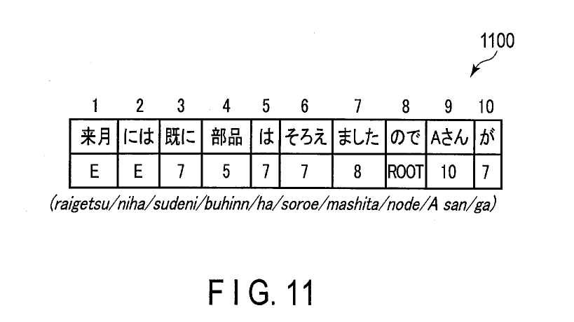

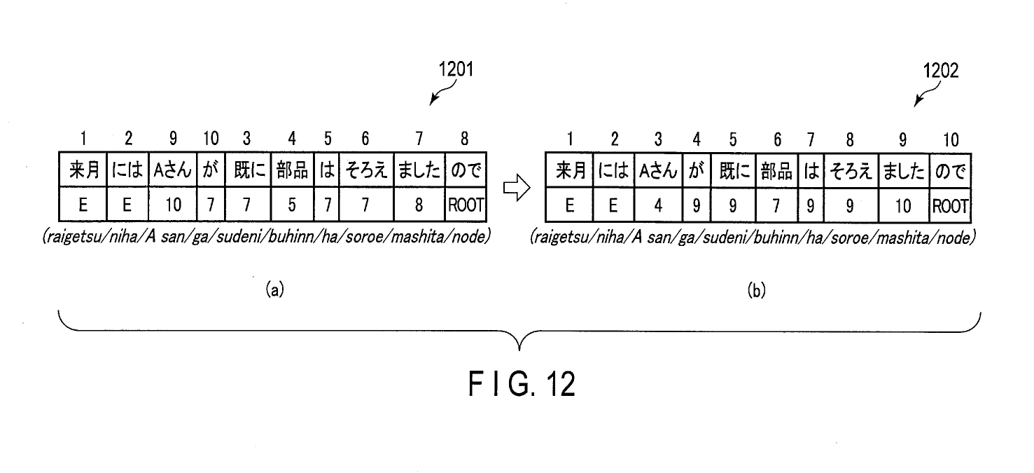

Next, an example of the correction process of the inversion will be described with reference to FIGS. 11 and 12. FIG. 11 is a table 1100 of the morpheme analysis result including an inversion, which is stored in the dependency source morpheme buffer 108.

Referring to a dependency destination morpheme 812 of the table 1100, the dependency destination morpheme corresponding to the morpheme “ [symbol] ” (“ga” in pronunciation) in the morpheme string “A [symbol] [symbol] ” (“A san/ga” in pronunciation) of identifiers 9 and 10 becomes “7” (that is, the morpheme “ [symbol] ” (“mashita” in pronunciation) of an identifier 7 of “ [symbol] / [symbol] ” (“soroe/mashita” in pronunciation)). Therefore, the dependency destination is present in the front of the morpheme “ [symbol] ” (“ga” in pronunciation).

Herein, in a case where the inversion corrector 902 has, for example, a correction rule “in a case where a dependency destination of a morpheme indicating a “ [symbol] ” postpositional article is present in the front of a sentence, the whole word including the “ [symbol] ” postpositional article is moved to the head of the sentence”, the morpheme string “A [symbol] / [symbol] ” is moved to the head of the sentence. A correction result of the inversion corrector 902 is illustrated in a table 1201 of FIG. 12(a).

The inversion corrector 902 corrects the identifiers and the dependency destination morphemes of the morphemes included in the table 1201 to be lined in order. As the correction result, a table 1202 of FIG. 12(b) is obtained. Specifically, the identifiers are sequentially renumbered, and the dependency destination morphemes are also corrected to have the original dependency relation in accordance with the renumbered identifiers.

Further, the correction of the inversion is not limited to the above description, and a general method of correcting the inversion may be use to similarly realize the invention.

According to the second embodiment described above, even in a case where there is an inversion of a sentence in addition to an insertion of a sentence, the inversion is corrected, it is determined whether the morpheme is the end expression, and the morpheme string is output based on the dependency relation stored in the buffer, so that the completely-linked phrase or sentence is output as the processing unit. Therefore, it is possible to detect an appropriate processing unit similarly to the first embodiment.

The instructions shown in the processing sequence in the above-described embodiment may be executed based on a software program. The same effect as that of the above-described detection apparatus may be obtained by storing the program in a general-purpose computer system in advance, and then reading the program. The instruction described in the above-mentioned embodiment may be recorded as a computer-executable program in a magnetic disk (flexible disk, hard disk, etc.), an optical disk (CD-ROM, CD-R, CD-RW, DVD-ROM, DVD+R, DVD+RW, Blu-ray (registered trademark) Disc, etc.), a semiconductor memory, or a similar type of recoding medium. Any recording format may be employed as long as the format is readable in a computer or an embedded system. The same operation as that of the detection apparatus of the above-described embodiment may be realized when the computer reads the program from the recording medium and the instructions described in the program is executed by the CPU based on the program. It is a matter of course that the computer may acquire and read the program through a network. In addition, an OS (operation system) running on the computer, a database management software, an MW (middleware) such as a network may perform some of the respect processes based on the instruction of the program stored in the computer or the embedded system from the recording medium for realizing this embodiment. Furthermore, the recording medium in this embodiment is not limited to a medium independent from the computer or the embedded system, and may be a recording medium which downloads the program transferred through a LAN or the Internet, and stores or temporarily stores the program. In addition, the number of recording mediums is not limited to “1”. Even a case where the process in this embodiment is performed from a plurality of recording mediums is also included in the case of the recording medium in this embodiment, and any configuration of the medium may be employed.

Further, the computer or the embedded system in this embodiment performs the respective processes in this embodiment based on the program stored in the recording medium, and may be configured by any one of a device such as a personal computer or a microcomputer and a system where a plurality of devices are connected through a network. In addition, the computer in this embodiment is not limited to the personal computer, and includes an arithmetic processing device included in an information processing apparatus, and a microcomputer. The computer in this embodiment collectively refers to an apparatus or a device which can realize the functions in this embodiment by a program.

While certain embodiments have been described, these embodiments have been presented by way of example only, and are not intended to limit the scope of the inventions. Indeed, the novel apparatuses, methods and computer readable media described herein may be embodied in a variety of other forms; furthermore, various omissions, substitutions and changes in the form of the apparatuses, methods and computer readable media described herein may be made without departing from the spirit of the inventions. The accompanying claims and their equivalents are intended to cover such forms or modifications as would fall within the scope and spirit of the inventions.

What is claimed is:

1. A detection apparatus comprising:
a morpheme analyzer that performs a morpheme analysis on a character string indicating an utterance content of a user to generate a morpheme analysis result including a plurality of morphemes;
a dependent structure analyzer that analyzes a dependency relation among the plurality of morphemes in the morpheme analysis result; and
an extractor that extracts a unit of morphemes having a completely-linked dependent structure from the morpheme analysis result based on the dependency relation.

2. The apparatus according to claim 1,
wherein the extractor extracts a first morpheme string including a sentence end expression or a phrase end expression as the unit of morphemes.

3. The apparatus according to claim 1, further comprising:
a first buffer that stores the morpheme analysis result as a scan morpheme string,
wherein when a first morpheme string including a sentence end expression as the unit of morphemes is extracted, the extractor deletes the morpheme string stored in the first buffer.

4. The apparatus according to claim 1,
a first buffer that stores the morpheme analysis result as a scan morpheme string,
wherein when the unit of morphemes is extracted, the first buffer stores a second morpheme string which is a difference between the scan morpheme string and the unit of morphemes, and additionally stores a new morpheme analysis result in the second morpheme string.

5. The apparatus according to claim 1, further comprising:
a dictionary storage that stores a conversion pattern of a colloquial expression and a written expression; and
a pattern converter that converts the colloquial expression into the written expression using the conversion pattern.

6. The apparatus according to claim 1, further comprising:
an acquirer that sequentially acquires an utterance of the user; and
a speech recognizer that performs a speech recognition on the utterance of the user to generate the character string as a speech recognition result.

7. The apparatus according to claim 1, further comprising:
an inversion corrector that corrects an inversion when the inversion is included in the character string.

8. A detection method comprising:
performing a morpheme analysis on a character string indicating an utterance content of a user to generate a morpheme analysis result including a plurality of morphemes;
analyzing a dependency relation among the plurality of morphemes in the morpheme analysis result; and
extracting a unit of morphemes having a completely-linked dependent structure from the morpheme analysis result based on the dependency relation.

9. The method according to claim 8,
wherein the extracting the unit of morphemes extracts a first morpheme string including a sentence end expression or a phrase end expression as the unit of morphemes.

10. The method according to claim 8, further comprising:
storing, in a first buffer, the morpheme analysis result as a scan morpheme string,
wherein when a first morpheme string including a sentence end expression as the unit of morphemes is extracted, the extracting the unit of morphemes deletes the morpheme string stored in the first buffer.

11. The method according to claim 8,
storing, in a first buffer, the morpheme analysis result as a scan morpheme string,
wherein when the unit of morphemes is extracted, the first buffer stores a second morpheme string which is a difference between the scan morpheme string and the unit of morphemes, and additionally stores a new morpheme analysis result in the second morpheme string.

12. The method according to claim 8, further comprising:
storing, in a dictionary storage, a conversion pattern of a colloquial expression and a written expression; and
converting the colloquial expression into the written expression using the conversion pattern.

13. The method according to claim 8, further comprising:
sequentially acquiring an utterance of the user; and
performing a speech recognition on the utterance of the user to generate the character string as a speech recognition result.

14. The method according to claim 8, further comprising:
correcting an inversion when the inversion is included in the character string.

15. A non-transitory computer readable medium including computer executable instructions, wherein the instructions, when executed by a processor, cause the processor to perform a method comprising:
performing a morpheme analysis on a character string indicating an utterance content of a user to generate a morpheme analysis result including a plurality of morphemes;
analyzing a dependency relation among the plurality of morphemes in the morpheme analysis result; and
extracting a unit of morphemes having a completely-linked dependent structure from the morpheme analysis result based on the dependency relation.

16. The medium according to claim 15,
wherein the extracting the unit of morphemes extracts a first morpheme string including a sentence end expression or a phrase end expression as the unit of morphemes.

17. The medium according to claim 15, further comprising:
storing, in a first buffer, the morpheme analysis result as a scan morpheme string,
wherein when a first morpheme string including a sentence end expression as the unit of morphemes is extracted, the extracting the unit of morphemes deletes the morpheme string stored in the first buffer.

18. The medium according to claim 15,
storing, in a first buffer, the morpheme analysis result as a scan morpheme string,
wherein when the unit of morphemes is extracted, the first buffer stores a second morpheme string which is a difference between the scan morpheme string and the unit of morphemes, and additionally stores a new morpheme analysis result in the second morpheme string.

19. The medium according to claim 15, further comprising:
storing, in a dictionary storage, a conversion pattern of a colloquial expression and a written expression; and
converting the colloquial expression into the written expression using the conversion pattern.

20. The medium according to claim 15, further comprising:
sequentially acquiring an utterance of the user; and
performing a speech recognition on the utterance of the user to generate the character string as a speech recognition result.
